(19) United States
(12) Patent Application Publication
(10) Pub. No.: US 2008/0024394 A1
(43) Pub. Date: Jan. 31, 2008

(54) PLASMA DISPLAY DEVICE

(76) Inventors: Hideaki OHKI, Tokyo (JP); Kenji Ishiwata, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/672,590

(22) Filed: Feb. 8, 2007

(30) Foreign Application Priority Data
Jul. 28, 2006 (JP) JP2006-205489

(51) Int. Cl. G09G 3/28

(52) U.S. Cl. 345/60

(57) ABSTRACT

In an address driving system for driving address electrodes of a display panel, GND for VCC is newly provided between an address driving board and an address bus board to organize two systems of GNDs (for VCC and for VH). Furthermore, in the GND for VCC, an impedance is applied onto a GND line between a connection point of the GND for VCC mounted on the address bus board and a point at which the GNDs are unified together. This impedance is assumed to be larger than an impedance of a parasitic inductance at a connection point of the GND for VCC of a VCC power supply smoothing capacitor on an address driving board side.

### CROSS-REFERENCE TO RELATED APPLICATION

The present application claims priority from Japanese Patent Application No. JP 2006-205489 filed on Jul. 28, 2006, the content of which is hereby incorporated by reference into this application.

### TECHNICAL FIELD OF THE INVENTION

The present invention relates to a technology for a plasma display device. In particular, it relates to a technology effectively applied to the circuit configuration of an address driving system for driving address electrodes of a display panel in a plasma display device.

### BACKGROUND OF THE INVENTION

Recent development of plasma display devices has been remarkable and they have been widely put into practical use. In particular, since the increase in screen size and the colorization can be easily achieved in an AC-type PDP (Plasma Display Panel) with a three-electrode-type surface discharge structure, their practical use and application for large-screen TV set and others have progressed.

Such an AC-type PDP having a three-electrode-type surface discharge structure is constituted of two glass substrates of a front glass substrate and a rear glass substrate. The front glass substrate is provided with X electrodes which are sustain electrodes formed of BUS electrodes and transparent electrodes and Y electrodes (scan electrodes). Also, address electrodes extending in a direction orthogonal to the sustain electrodes are disposed on the rear glass substrate. Display cells which generate discharge light by means of these electrodes are formed at regions defined by the sustain electrodes and the address electrodes which cross with each other.

A driving circuit for the AC-type PDP with a three-electrode-type surface discharge structure includes a control circuit which forms a control signal for controlling a driving circuit of a panel by an interface signal inputted externally, an X electrode driving circuit for driving panel electrodes by this control signal, a scan electrode driving circuit, and an address electrode driving circuit. In this circuit configuration, a circuit for selectively applying a driving pulse to each electrode is required for scan driver circuits and address driver circuits, and IC elements are used as main circuit components in general.

For example, the address driver circuits have the configuration including a plurality of address driving boards on which an address driver circuit which supplies display data to a display panel is mounted and an address bus board which distributes and supplies display data to these address driving boards. In this configuration, as a technology for suppressing a parasitic inductance of a GND line of an address discharge path, (1) a method of reinforcing the GND line and (2) a method of shortening the GND line are known.

(1) The method of reinforcing the GND line includes: (a) increasing the number of connector pins between the address driving board and the address bus board; and (b) using a multilayered board for the address bus board.

(2) The method of shortening the GND line include: (a) connecting the address driving boards and the address bus board through thermal compression so as to reduce a parasitic impedance of a connector and others, and (b) disposing a driving IC on the address driving board as close as possible to the address bus board.

### SUMMARY OF THE INVENTION

Incidentally, according to the examination by the inventors of the present invention, the following problems occur in (1) the method of reinforcing the GND line and (2) the method of shortening the GND line described above.

(1) In the method of reinforcing the GND line, cost of members increases, and it is disadvantageous in terms of cost.

(2) In the method of shortening the GND line, the connection through thermal compression has to be used for both the input/output connections of the address driving boards (to the address bus board and the display panel). Therefore, manufacturing process and facilities thereof require enormous amount of time for inspection and enormous investment, and it is disadvantageous in terms of cost. Moreover, restrictions in IC arrangement adversely affect and the number of ICs mounted on each address driving board is decreased, and the number of address driving boards is thus increased. Accordingly, the number of assembling processes is increased, and it is disadvantageous in terms of cost.

In such a circumstance, an object of the present invention is to provide a plasma display device capable of solving the above-described problems and including an address driving system which is advantageous in terms of cost, by achieving application of impedance at low cost, reducing operation processes of an address driving board, implementing TCP (Tape Carrier Package) (or COF (Chip on Film)) mounting of the address driving board, and minimizing a change in design, manufacture and facilities.

The above and other objects and novel characteristics of the present invention will be apparent from the description of this specification and the accompanying drawings.

The typical ones of the inventions disclosed in this application will be briefly described as follows.

In the present invention, in an address driving system for driving address electrodes of a display panel, GND for low-voltage power supply is newly provided between an address driving board and an address bus board to organize two systems of GNDs (for low-voltage power supply and for high-voltage power supply). Furthermore, in the GND for low-voltage power supply, an impedance is applied onto a GND line between a connection point of the GND for low-voltage power supply mounted on the address bus board and a point where the GNDs are unified together. This impedance is assumed to be larger than an impedance of a parasitic inductance on an address driving board side at a connection point of the GND for low-voltage power supply of a low-voltage power supply smoothing capacitor.

The effects obtained by typical aspects of the present invention will be briefly described below.

According to the present invention, it is possible to provide a plasma display device having an address driving system capable of achieving cost reduction.

### BRIEF DESCRIPTIONS OF THE DRAWINGS

FIG. 1 is a block diagram showing the configuration of main components in a driving circuit for driving the electrodes of a display panel and performing a display operation of the display panel in a plasma display device according to one embodiment of the present invention;

FIG. 2 is an explanatory diagram showing an address driving system in the configuration according to one embodiment of the present invention;

FIG. 3 is an explanatory diagram showing an address driving system according to a first configuration for comparison with the present invention; and

FIG. 4 is an explanatory diagram showing an address driving system according to a second configuration for comparison with the present invention.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

<Plasma Display Device>

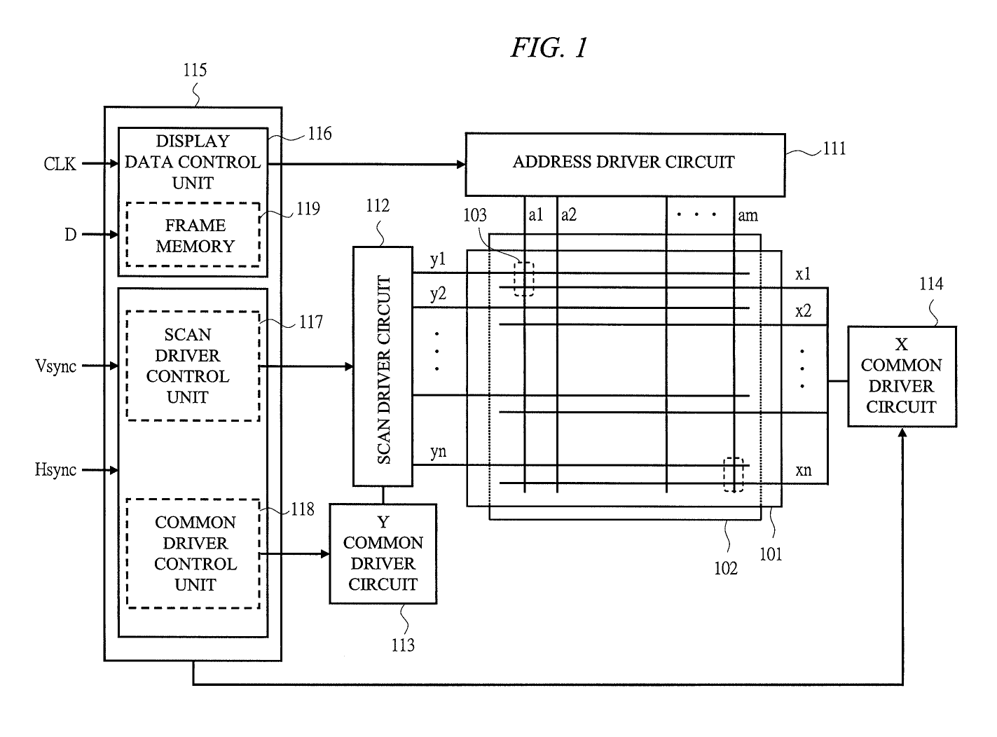

FIG. 1 is a block diagram showing the configuration of main components in a driving circuit for driving the electrodes of a display panel and performing a display operation of the display panel in a plasma display device according to one embodiment of the present invention.

As shown in FIG. 1, in the driving circuit for the display panel, various driving circuits (drivers) such as a control circuit 115, an X electrode driving circuit, a Y electrode driving circuit, and an address electrode driving circuit are provided for a front glass substrate 101 and a rear glass substrate 102. The front glass substrate 101 is provided with a plurality of X electrodes (x1, x2, . . . , xn) and a plurality of Y electrodes (y1, y2, . . . , yn). The rear glass substrate 102 is provided with a plurality of address electrodes (a1, a2, . . . , am).

In this example, in particular, the control circuit 115 includes a display data control unit 16 provided with a frame memory 119, and driver control units. The driver control units are a scan driver control unit 117 and a common driver control unit 118. Also, as drivers, an address driver circuit 111, an X common driver circuit 114, a scan driver circuit 112, and a Y common driver circuit 113 are provided.

The control circuit 115 generates control signals for controlling each driver of the display panel by using interface signals inputted externally {CLK (clock), D (data), Vsync (vertical synchronization), Hsync (horizontal synchronization)}, thereby controlling each driver. The address driver circuit 111 is controlled by the display data control unit 116 based on a data signal stored in the frame memory 119, and the scan driver circuit 112 is controlled by the scan driver control unit 117. Furthermore, the X common driver circuit 114 and the Y common driver circuit 113 are controlled by the common driver control unit 118.

Each of the drivers drives the electrodes according to the control signals from the control circuit 115. On a display screen of the display panel, an address discharge for determining a display cell 103 is generated by the driving of the address driver circuit 111 and the scan driver circuit 112. Next, a sustain discharge for lighting the display cell 103 is generated by the driving of the X common driver circuit 114 and the Y common driver circuit 113.

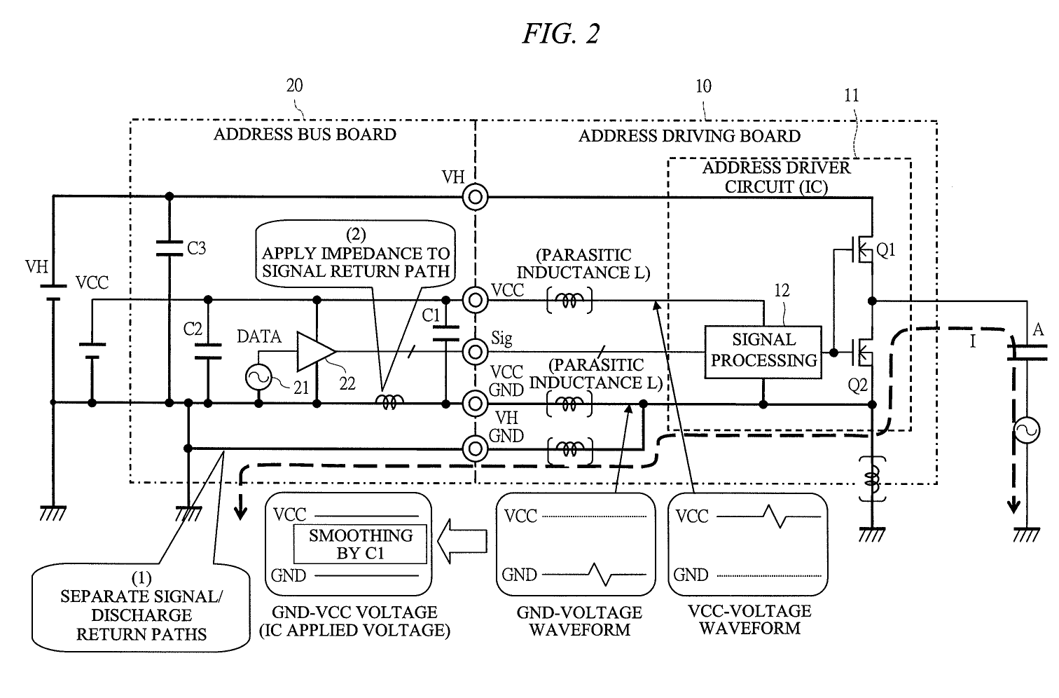

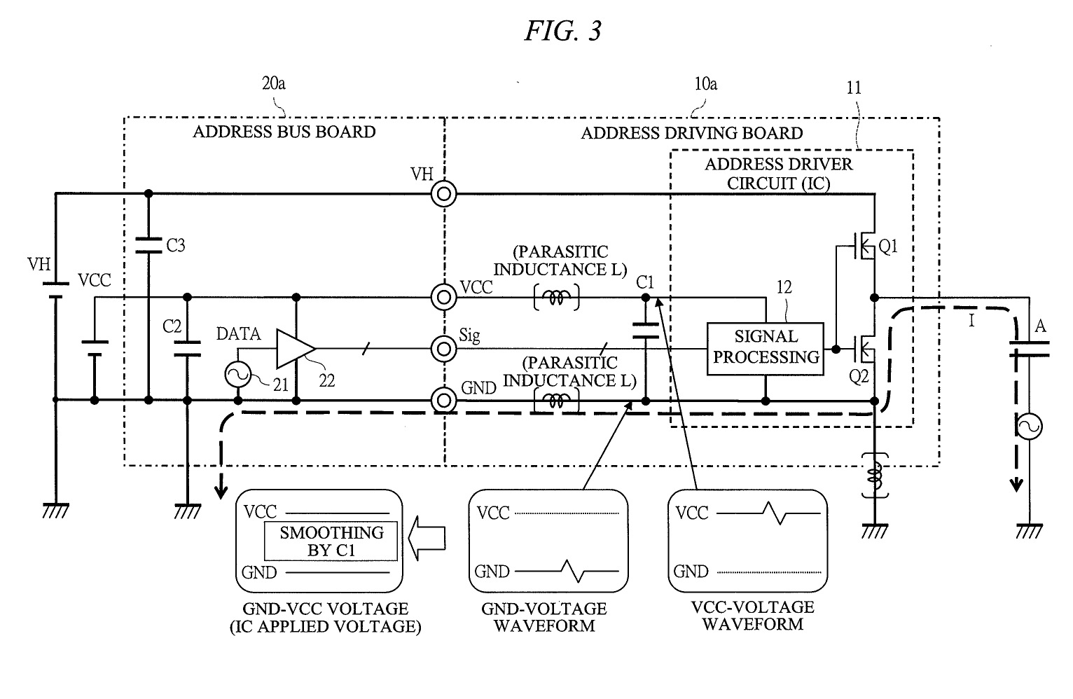

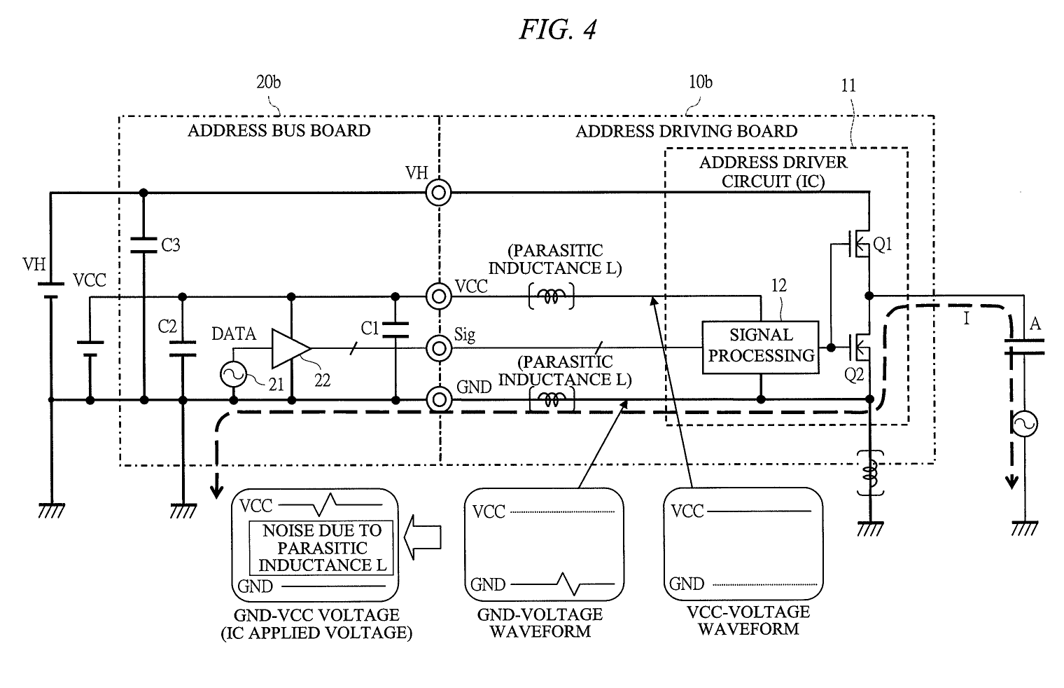

A feature of the present embodiment lies in the address driving system including the address driver circuit 111. A first configuration for comparison with the present invention (FIG. 3: a power supply smoothing capacitor for low-voltage signal processing unit is mounted on a driving board), a second configuration for comparison with the present invention (FIG. 4: a power supply smoothing capacitor for low-voltage signal processing unit is mounted on a signal supply board), and the configuration of one embodiment of the present invention (FIG. 2) are sequentially described below, and the details of the configuration of one embodiment of the present invention are described in the section of the configuration of one embodiment of the present invention.

### First Configuration for Comparison with the Present Invention

FIG. 3 is an explanatory diagram showing an address driving system in which a power supply smoothing capacitor for low-voltage signal processing unit is mounted on an address driving board, as a first configuration for comparison with the present invention.

In FIG. 3, the address driving system includes address driving boards 10a, which are a plurality of driving boards (only one board is shown in the diagram) on which an address driver circuit which is a data driver circuit for supplying display data to a display panel is mounted, and an address bus board 20a, which is a signal supply board for distributing and supplying display data to the plurality of address driving boards 10a. In this configuration, the address driving system is connected to a high-voltage power supply (VH), a low-voltage power supply (VCC), and an address electrode (A) of the display panel, which are all provided externally.

The address driving board 10a is formed of a flexible board, and an address driver circuit 11 and a power supply smoothing capacitor Cl for a low-voltage signal processing unit of this address driver circuit 11 are mounted on this flexible board.

The address bus board 20a is formed of a rigid board, and a data generation source 21 for display data, a buffer 22 for transmitting the display data from this data generation source 21, a power supply smoothing capacitor C2 for VCC, and a power supply smoothing capacitor C3 for VH are mounted on this rigid board.

This first configuration has a problem that TCP (Tape Carrier Package) (or COF (Chip On Film)) for promoting the reduction in manufacturing cost of the address driving boards 10a cannot be implemented. In other words, the reduction of the manufacturing cost can be achieved by, for example, reducing the number of operation processes. For its achievement, the implementation of TCP (COF) is important. In this TCP (COF) mounting of the address driving boards 10a, it is impossible to mount components which require soldering such as the power supply smoothing capacitor C1. Therefore, they are relocated from the address driving board 10a to the address bus board 20a. That is, the second configuration described next is formed.

The TCP (COF) mounting mentioned here indicates a mounting structure based on a gang bonding method, in which higher-density mounting is possible and productivity can be expected to be improved, instead of a wire bonding method which has been generally used. Further, in the gang bonding method, a plurality of IC chips of driving ICs are successively mounted on a flexible board formed in a tape shape by a reel carrier method, and individual modules each having one driving IC mounted thereon are punched from the board.

Examples of the mounting structure by this gang bonding method are broadly divided into two types. One type is a mounting structure based on COF (Chip On Film). In this structure, a gold bump is attached to a terminal of an IC chip, and the terminal to which the gold bump is attached and a tinned terminal on the flexible board are bonded through thermal compression to form a gold-tin eutectic alloy bonding, thereby connecting the terminals. After the connection of the terminals, a space between the IC chip and the flexible board is filled with sealing resin called underfill, and the resin is then dried to complete the operation.

The other type is a mounting structure based on TCP (Tape Carrier Package). In this structure, a gold bump is similarly attached to a terminal of an IC chip, and a hole called a device hole is provided on a flexible board side and a terminal for connection protrudes as a finger lead in this hole. The finger lead is plated with tin, and after the IC chip is mounted and connected by means of the gold-tin eutectic alloy bonding through the thermal compression in the same manner, protective sealing resin is applied to the mounting surface of the IC chip at the position of the device hole and the resin is then dried for protecting the connecting portion.

A feature of this TCP type is as follows. That is, since the terminal on the IC chip side is connected to the terminal of the device hole portion as described above, the IC chip can be mounted in an arbitrary direction with respect to the orientation of the flexible board. Also, while the direction of mounting the IC chip with respect to the orientation of the flexible board is self-defined in the COF type, mounting in a direction reverse to the direction of the COF type is possible in the TCP type.

The address driving system according to the present embodiment is suitable for the mounting structure of TCP type. However, as a matter of course, it can be applied to a mounting structure of COF type.

### Second Configuration for Comparison with the Present Invention

FIG. 4 is an explanatory diagram showing an address driving system in which a power supply smoothing capacitor for low-voltage signal processing unit is mounted on an address bus board, as a second configuration for comparison with the present invention.

In FIG. 4, similar to the first configuration, the address driving system includes a plurality of address driving boards 10a (only one board is shown in the diagram) and an address bus board 20a. The difference therebetween lies in that only the address driver circuit 11 is mounted on the address driving board 10b and a power supply smoothing capacitor C1 for low-voltage signal processing unit is mounted on the address bus board 20b in addition to the data generation source 21, the buffer 22, the power supply smoothing capacitor C2 for VCC, and the power supply smoothing capacitor C3 for VH.

In this second configuration, TCP (COF) for promoting the reduction in manufacturing cost of the address driving boards 10a can be implemented. However, since the power supply smoothing capacitor C1 is mounted on the address bus board 20b, noise occurs on a GND line of the address driving board 10b due to parasitic inductance (L). This noise is applied to the power supply smoothing capacitor C2 for VCC, and the noise components are superposed on the VCC voltage and then undesirably supplied to the IC of the address driver circuit 11 as VCC. For its prevention, the configuration according to one embodiment of the present invention described next is formed.

### Configuration According to One Embodiment of the Present Invention

FIG. 2 is an explanatory diagram showing an address driving system in which a power supply smoothing capacitor for low-voltage signal processing unit is mounted on an address bus board and two systems of GND lines are provided, and impedance is applied onto a GND line for low-voltage power supply, as the configuration according to one embodiment of the present invention.

In FIG. 2, similar to the first and second configurations, the address driving system includes a plurality of address driving boards (driving boards) 10 (only one board is shown in the diagram) and an address bus board (signal supply board) 20. The difference therebetween lies in that GND for VCC is newly provided between the address driving board 10 and the address bus board 20 to organize two systems of GNDs (for VCC and for VH). Furthermore, in the GND for VCC, an impedance is applied onto the GND line between a connection point of the GND for VCC mounted on the address bus board 20 and a point at which GNDs are unified together.

The address driving board 10 is formed of a flexible board, and an IC chip of an address driver circuit (data driver circuit) 11 is mounted on this flexible board in the above-described mounting structure of TCP (COF) type. This address driver circuit 11 includes a low-voltage signal processing unit 12 for performing signal processing of display data, transistors Q1 and Q2 which are controlled to turn ON and OFF by an output signal from this low-voltage signal processing unit 12, and others.

On this address driving board 10, electrical connection with the IC chip of the address driver circuit 11 is made through a wiring pattern on the address driving board 10. A connection terminal for VH is connected to the transistor Q1 of the address driver circuit 11, a connection terminal for VCC is connected to the low-voltage signal processing unit 12, a connection terminal for display data (Sig) is connected to the low-voltage signal processing unit 12, and a connection terminal for VCC ground (VCCGND) and a connection terminal for VH ground (VHGND) are combined and connected to the low-voltage signal processing unit 12 and the transistor Q2. Also, a connection point between the transistors Q1 and Q2 is connected to an address electrode (A) of a display panel.

The address bus board 20 is formed of a rigid board, and a data generation source 21 for display data, a buffer 22 for transmitting the display data from this data generation source 21, a power supply smoothing capacitor C1 for the low-voltage signal processing unit 12 of the address driver circuit 11, a power supply smoothing capacitor C2 for VCC, and a power supply smoothing capacitor C3 for VH are soldered and mounted on this rigid board.

On this address bus board 20, electrical connection with various mounted components is made through a wiring pattern on the address bus board 20. A connection terminal for VH is connected to the power supply smoothing capacitor C3. Also, a connection terminal for VCC is connected to the buffer 22 and the power supply smoothing capacitors C1 and C2, a connection terminal for Sig is connected to the buffer 22, a connection terminal for VCCGND is connected to the data generation source 21, the buffer 22, and the power supply smoothing capacitors C2 and C3, and a connection terminal for VHGND is connected to the power supply smoothing capacitors C2 and C3. Also, a connection terminal for VH is connected to a high-voltage power supply (VH), and a connection terminal for VCC is connected to a low-voltage power supply (VCC), respectively.

The operation of this address driving system is as follows. On the address bus board 20, display data from the data generation source 21 is transmitted through the buffer 22 and supplied to the address driver circuit 11 of the address driving board 10. In the address driver circuit 11, the received display data is subjected to signal processing in the low-voltage signal processing unit 12 and ON/OFF of the transistors Q1 and Q2 are controlled, thereby performing the operations of charging and discharging the address electrode (A) of the display panel.

In this address driving system, the power supply smoothing capacitors C1 for low-voltage signal processing unit 12 of the address driver circuit 11 mounted on the address driving board 10 is mounted on the address bus board 20, and a parasitic impedance is generated by a power supply line for VCC and a GND line for the return thereof. In this configuration, the GND line connecting the address driving board 10 and the address bus board 20 has two systems such as a GND line for VCC and a GND line for VH supplied to the display panel.

In particular, theses two systems of the GND line for VCC and the GND line for VH are separated from each other near the address driver circuit 11 of the address driving board 10. On the address bus board 20 side, these two systems of lines are combined together near a position connected to a reference GND portion (for example, chassis metal which retains the display panel) serving as an operation reference of the display panel. On the GND line for VCC, an impedance is applied between a connection point of the power supply smoothing capacitor C1 and a point combined to the GND line for VH.

The impedance between the connection point of the power supply smoothing capacitor C1 and the point combined to the GND line for VH is formed by a parasitic element using a pattern in the address bus board 20. Alternatively, it is formed by a resistor or inductance circuit element mounted by soldering on the address bus board 20. On the other hand, the impedance of the GND line for VCC in the address driving board 10 is formed by a parasitic element using a board pattern. In the case where an impedance is formed by using a board pattern, the amount of impedance components can be increased by, for example, increasing the length of the board pattern.

In this address driving system, the impedances of the GND line for VCC and the GND line for VH have the following relation:

(1) The amount of impedance components of the GND line for VCC is larger than the amount of impedance components of the GND line for VH;

(2) The amount of impedance components between the connection point of the power supply smoothing capacitor C1 of the GND line for VCC and the point combined to the GND line for VH is larger than the amount of impedance components of the GND line for VH on the address bus board 20;

(3) The amount of impedance components between the connection point of the power supply smoothing capacitor C1 of the GND line for VCC and the point combined to the GND line for VH is equal to or larger than the amount of impedance components between the point where the GND line for VCC is separated near the address driver circuit 11 of the address driving board 10 and the connection point of the power supply smoothing capacitor C1 on the address bus board 20 side; and

(4) The amount of impedance components between the connection point of the power supply smoothing capacitor C1 of the GND line for VCC and the point combined to the GND line for VH is larger than the amount of impedance components of the GND line for VH on the address bus board 20 and is equal to or larger than the amount of impedance components between the point where the GND line for VCC is separated near the address driver circuit 11 of the address driving board 10 and the connection point of the power supply smoothing capacitor C1 on the address bus board 20 side.

According to the configuration of the present embodiment described above, (1) a charge/discharge current (I) flowing through the capacitance of the address electrode (A) flows through the GND line for VH with low impedance and does not flow through the GND line for VCC. (2) Due to the parasitic inductance of the GND line for VH, noise occurs. This noise is voltage-divided by the parasitic inductance components of the GND line for VCC on the address driving board 10 side and the applied impedance on the address bus board 20 side and is then applied to the power supply smoothing capacitor C2 for VCC. The noise components are then superposed on the VCC voltage and supplied as VCC for the address driver circuit 11. (3) The applied noise between VCC and GND of the address driver circuit 11 is suppressed by the canceling effect owing to the above-described (1) and (2). (4) Thus, by providing two systems of GNDs and applying an impedance onto the GND line for VCC, the increase of VCC application noise is prevented even if the power supply smoothing capacitor C1 is relocated from the address driving board 10 to the address bus board 20.

Therefore, according to the present embodiment, effects described below can be obtained.

(1) The impedance to be applied can be obtained by forming a parasitic inductance by an extension of the GND line. Also, since the number of connection terminals on the GND line between the address driving board 10 and the address bus board 20 does not have to be increased, it is possible to achieve the application of impedance at low cost.

(2) Since the number of components on the address driving board 10 can be reduced, the operation processes of the address driving board 10 can be reduced. Furthermore, TCP (COF) mounting can be easily implemented.

(3) Since the components and connection configuration are not changed, a change in design, manufacture, and facilities can be minimized, and it is possible to form an address driving system which is advantageous in terms of cost.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention relates to a technology for a plasma display device. In particular, it is usable for the circuit configuration of an address driving system for driving address electrodes of a display panel in a plasma display device.

What is claimed is:

1. A plasma display device comprising:
a plurality of driving boards on which a data driver circuit for supplying display data to a display panel is mounted; and
a signal supply board for distributing and supplying the display data to the plurality of driving boards,
wherein a power supply smoothing capacitor for a low-voltage signal processing unit of the data driver circuit mounted on the driving board is mounted on the signal supply board, and a parasitic impedance is generated by a power supply line for low-voltage power supply and a GND line for return thereof,
a GND line connecting the driving board and the signal supply board includes two systems such as a first GND line for low-voltage power supply and a second GND line for high-voltage power supply supplied to the display panel,
the first and second GND lines of the two systems are separated from each other near the data driver circuit on the driving board and are combined near a position connected to a reference GND portion serving as an operation reference of the display panel on a signal supply board side, and
on the first GND line, an impedance is applied between a connection point of the power supply smoothing capacitor and a point combined to the second GND line.

2. The plasma display device according to claim 1,
wherein an amount of impedance components of the first GND line is larger than an amount of impedance components of the second GND line.

3. The plasma display device according to claim 2,
wherein an amount of impedance components between the connection point of the power supply smoothing capacitor of the first GND line and the point combined to the second GND line is larger than an amount of impedance components of the second GND line on the signal supply board.

4. The plasma display device according to claim 2,
wherein an amount of impedance components between the connection point of the power supply smoothing capacitor of the first GND line and the point combined to the second GND line is equal to or larger than an amount of impedance components between a point where the first GND line is separated near the data driver circuit of the driving board and a connection point of the power supply smoothing capacitor on the signal supply board side.

5. The plasma display device according to claim 2,
wherein an amount of impedance components between the connection point of the power supply smoothing capacitor of the first GND line and the point combined to the second GND line is larger than an amount of impedance components of the second GND line on the signal supply board and is equal to or larger than an amount of impedance components between a point where the first GND line is separated near the data driver circuit of the driving board and a connection point of the power supply smoothing capacitor on the signal supply board side.

6. The plasma display device according to claim 2,
wherein an impedance of the first GND line in the driving board is increased by a parasitic element using a board pattern.

7. The plasma display device according to claim 2,
wherein an impedance between the connection point of the power supply smoothing capacitor on the first GND line in the signal supply board and the point combined to the second GND line is provided by a parasitic element using a board pattern.

8. The plasma display device according to claim 2,
wherein an impedance between a connection point of the power supply smoothing capacitor on the first GND line in the signal supply board and a point combined to the second GND line is provided by a resistor or inductance circuit element.

9. The plasma display device according to claim 1,
wherein the driving boards are flexible boards, and
the signal supply board is a rigid board.

10. The plasma display device according to claim 9,
wherein the data driver circuit mounted on the flexible board is mounted in a structure of either TCP type or COF type.
